(19) United States
(12) Patent Application Publication
(10) Pub. No.: US 2014/0305275 A1
(43) Pub. Date: Oct. 16, 2014

(54) REVERSE DIE CUTTING INSERT AND METHOD

(71) Applicant: Michigan Lasercut, Kentwood, MI (US)

(72) Inventor: Steven Schroder, Grand Rapids, MI (US)

(73) Assignee: Michigan Lasercut, Kentwood, MI (US)

(21) Appl. No.: 14/248,466

(22) Filed: Apr. 9, 2014

Related U.S. Application Data
(60) Provisional application No. 61/810,474, filed on Apr. 10, 2013.

(51) Int. Cl. B26D 3/08

(52) U.S. Cl. CPC B26D 3/085
USPC 83/880; 83/879

(57) ABSTRACT

A reverse die cutting apparatus includes a counter die having at least one receiving aperture disposed thereon in which an insert having a blade is received. The receiving aperture disposed on the counter die is a through aperture having a specific geometric configuration that correlates to a perimeter configuration of the insert. The insert is received in the counter die and the blade portion of the insert is customizable due to a forming process, thereby providing a reverse cut to a substrate in a die converting process.

### CROSS-REFERENCE TO RELATED APPLICATION

This application claims the benefit under 35 USC §119(3) of U.S. Provisional Application No. 61/810,474, filed Apr. 20, 2013, entitled REVERSE DIE CUTTING INSERT AND METHOD, the entire contents of which are incorporated herein by reference.

### FIELD OF THE INVENTION

The present invention generally relates to a reverse die cutting insert and method of using the same. Specifically, the present invention relates to a reverse die cutting insert used in a die converting process which makes for a reverse or inside cut on a converted material.

### BACKGROUND OF THE INVENTION

It is noted that the die converting process is a suitable process for a variety of substrates including, but not limited to, plastic, paperboard, and Mylar. However, for purposes of this application, the paperboard converting process will be used as an example.

Generally, in the paperboard industry, a reverse cut, or “rev cut” as known in the industry, may be desired to provide an offset partial cut on both sides of a converted substrate, thereby providing for a tear open feature which can facilitate the opening of cartons and can further provide an element of control by dampening the opening of a carton. Presently, reverse cut scores, having a planar portion with a linearly aligned blade extending therefrom, are positioned in a milled-out cavity or channel formed in a counter die. A reverse cut score is a chemically etched steel plate which usually includes a straight cutting edge that is used to cut an inside surface of a blank in a die converting process. In milling the channels in the counter die, it is difficult to provide a smooth and even bottom surface of the channel, such that it is often difficult to get the depth and dimensions within a needed tolerance for a particular job. The non-uniform channels make for extensive and precise milling which is time consuming in order to provide a flat and even bottom to the channel that will properly receive a straight-lined reverse cut score. Further, it is expensive to mill these channels to a precise depth and dimension on the counter die to provide appropriate channel dimensions. In the die converting process, it is necessary to be able to repeat a die converting step numerous times once the counter die is set in a “make ready” state. Currently, when a reverse cut score is placed in a milled channel on the counter die, an adhesive is used to help retain the reverse cut score in place. During the die converting process, the counter die can heat up and cause the adhesive to become warm and reconstitute which leads to inadvertent repositioning of the reverse cut score within the channel. This movement of the reverse cut score causes manufacturers to “lose the cut”, such that significant down time is necessary in order for a manufacturer to reposition the reverse cut score within the counter die channel to provide a proper cut. Further, the straight blades found in present day reverse cut scores are difficult to place in custom rev cut jobs that call for any number of arching or angled rev cuts.

Thus, it is necessary to provide a method of reverse cutting in a die converting process, wherein the reverse cut is easily and cost effectively customizable and readily configured and properly retained on a counter die for high volume repeated cycles.

### BRIEF SUMMARY OF THE INVENTION

One aspect of the present invention includes a counter die having a relief or aperture disposed therethrough, wherein the aperture is adapted to receive an insert. The insert includes a body portion and a raised blade portion extending upwardly from the body portion such that the blade portion is adapted to provide a reverse cut to an inside substrate as used in the die converting process.

Another aspect of the present invention includes a reverse die cutting apparatus for use with a substrate in a die converting process. The apparatus includes a counter die having a generally planar body portion and a receiving aperture disposed through the planar body portion. The receiving aperture includes a geometric configuration relative to an outer perimeter. An insert having a generally planar body portion, includes a geometric configuration disposed about its outer perimeter that is complementary to the geometric configuration of the receiving aperture. In this way, the insert is configured to be received within the receiving aperture disposed through the generally planar body portion of the counter die. One or more blades extend outwardly from the generally planar body portion of the insert, and the insert, as received in the receiving aperture of the counter die, is configured to provide a reverse cut to a substrate during a die converting process.

Another aspect of the present invention includes a method of providing a reverse cut in a substrate in a die converting process. The method includes the steps of providing a counter die having a generally planar body portion and forming a receiving aperture through the body portion of the counter die. The receiving aperture is formed having a first geometric configuration disposed about an outer perimeter. The method further includes the step of providing an insert having a generally planar body portion and having a second geometric configuration disposed about an outer perimeter, wherein the second geometric configuration is complementary to the first geometric configuration of the counter die. One or more blade portions are formed on the insert, and the insert is positioned in the receiving aperture of the counter die. The counter die and insert are then positioned in a die press where a substrate is converted, such that the blade portions of the insert provide a reverse cut on an underside of the substrate during the converting step.

Another aspect of the present invention includes a reverse die cutting apparatus for use with a substrate in a die converting process. A counter die, having a generally planar body portion, includes a top surface and a bottom surface. A receiving aperture is disposed through the planar body portion, and includes a first geometric configuration relative to its outer perimeter. An insert includes a generally planar body portion and a second geometric configuration disposed about an outer perimeter. The second geometric configuration is complementary and smaller than the first geometric configuration of the receiving aperture. As such, the insert is received within the receiving aperture disposed through the generally planar body portion of the counter die. One or more blades extending outwardly from the generally planar body portion of the insert and are raised relative to the top surface of the counter die in assembly.

Yet another aspect of the present invention includes a method of providing a reverse cut in a die converting process which includes the steps of providing a counter die having one or more apertures disposed therethrough, inserting an insert into one of the apertures disposed on the counter die, such that the insert is frictionally fit within the associated aperture, providing a blade portion on the insert, wherein the blade portion is adapted to provide a reverse cut to a substrate in a die converting process.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a fragmentary top plan view of a counter die having an aperture therethrough;

FIG. 2 is a top plan view of a reverse cut insert;

FIG. 3 is a perspective view of the reverse cut insert of FIG. 2;

FIG. 4 is a top plan view of the reverse cut insert of FIG. 2, as inserted into the aperture of the counter die of FIG. 1;

FIG. 5 is a top plan view of the counter die and reverse cut insert of FIG. 4 having an adhesive layer applied thereto; and

FIG. 6 is a bottom plan view of the counter die and reverse cut insert of FIG. 5.

### DETAILED DESCRIPTION OF THE PREFERRED EMBODIMENTS

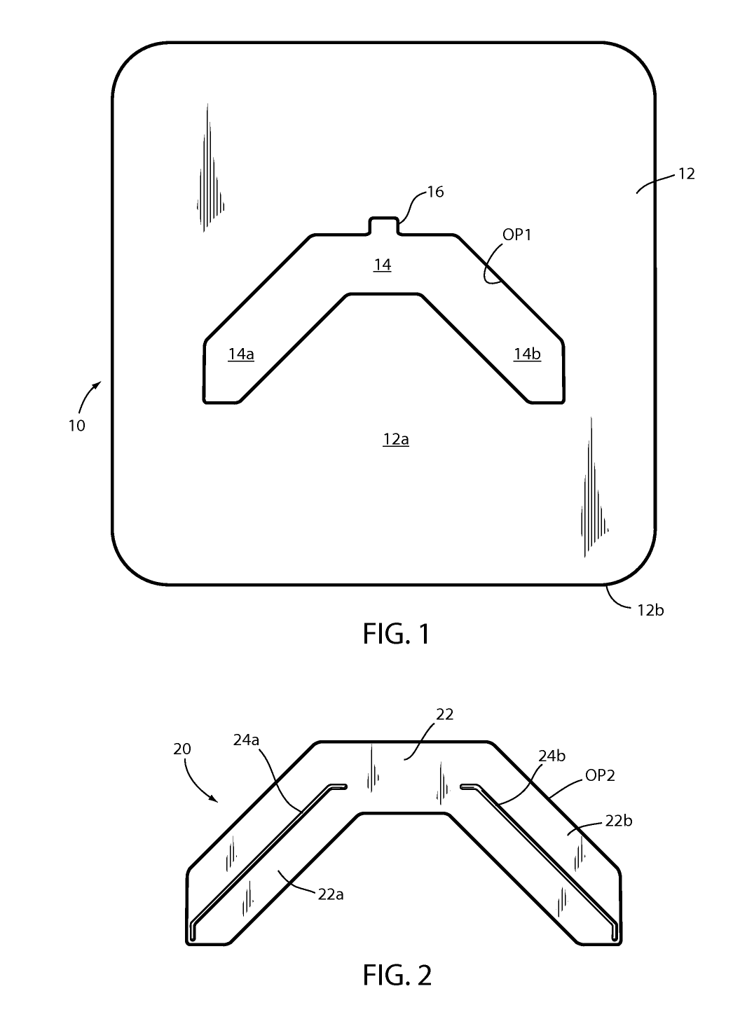

For the purposes of description herein, the terms “upper,” “lower,” “right,” “left,” “rear,” “front,” “vertical,” “horizontal,” “top,” “bottom” and derivates thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification, are simply exemplary embodiments. Hence, specific dimensions and other physical characteristics relating to the embodiments disclosed herein are not to be construed as limiting, unless expressly stated otherwise. Further, it is noted that the die converting process is a suitable process for a variety of substrates including, but not limited to, plastic, paperboard and Mylar. However, for purposes of this application, paperboard, as used in carton manufacturing, will be the referred to substrate.

Referring now to FIG. 1, a counter die 10, also referred to as a counterplate, is shown having a generally planar body portion 12 and a receiving aperture 14 disposed through the planar body portion 12. The planar body portion 12 includes a top surface 12a and a bottom surface 12b. The counter die 10 can be a standard counter die produced using a 0.04 inch metal substrate such as stainless steel. It is noted that other counter die materials having a range of thicknesses are also suitable for use with the present invention. The counter die 10 is generally sized to correspond to the size of a flat anvil against which a paperboard substrate is cut in a die converting process as the counter die is pressed against the flat anvil in a die press. Average sizes for a counter die or counterplate 10 shown in FIG. 1 may be 30″×42″, 41″×57″ and 44″×67″. When using a polymeric material for the counter die 10, the size of the counter die 10 may be 8″×12″. Other size counter dies will be appreciated by one of ordinary skill in the art, such that the sizes noted above are exemplary only and are not meant to limit the scope of the present invention. As shown in FIG. 1, the receiving aperture 14 includes two wing portions 14a, 14b, which gives the receiving aperture 14 a specific geometric configuration relative to an outer perimeter OP1 thereof that correlates to an associated insert as further described below. A relief notch 16 is further included in receiving aperture 14 along the outer perimeter OP1.

Referring now to FIG. 2, an insert 20 is shown having a body portion 22 which includes wing portions 22a, 22b, such that the insert 20 has an overall geometric configuration relative to an outer perimeter OP2 of the insert 20 that correlates to or is complimentary to the geometric configuration of receiving aperture 14 shown in FIG. 1. Disposed along the wing portions 22a, 22b are raised blade portions 24a, 24b respectively. It is contemplated that the insert 20 can be made from a metallic material, which is in a range from about 0.07 to 0.08 inches thick. Much like the material used for the counter die, the insert 20 can be made from a variety of materials, however, the insert 20 will generally have a starting material thickness that is greater than the thickness of the counter die 10. The blade portions 24a, 24b make the insert 20 a reverse cut insert which is adapted to be received in receiving aperture 14 of the counter die 10. The blade portions 24a, 24b can be formed in a variety of ways, such as chemical etching or milling the body portion 22 such that the blade portions 24a and 24b are raised above the planar body portion 22. Generally, the body portion 22 will be milled to a thickness that corresponds with the thickness of the counter die 10, such that the blade portions 24a, 24b, as shown in FIG. 2, could be about 0.02 to 0.04 inches raised from the generally planar body portion 22 of the insert 20. The height of the blade portions 24a, 24b can vary from job to job, and also the height of the flat anvil used in the die converting process could also be varied to provide a specific cut depth for a particular project. The insert 20 and receiving aperture 14 can be programmed using the same computer aided design software used to make a corresponding die, such that accuracy between components is consistent. In use, the blade portions 24a, 24b will cut a paperboard substrate as the counter die 10 is pressed against a flat anvil in a die converting process. This provides for a partial cut through the substrate to aid in opening of cartons created using the counter die 10 and insert 20 of the present invention. Further, it is contemplated that the blade portions 24a, 24b can be milled to define scoring rules that provide creases in a paperboard substrate, as opposed to actual cuts in the substrate.

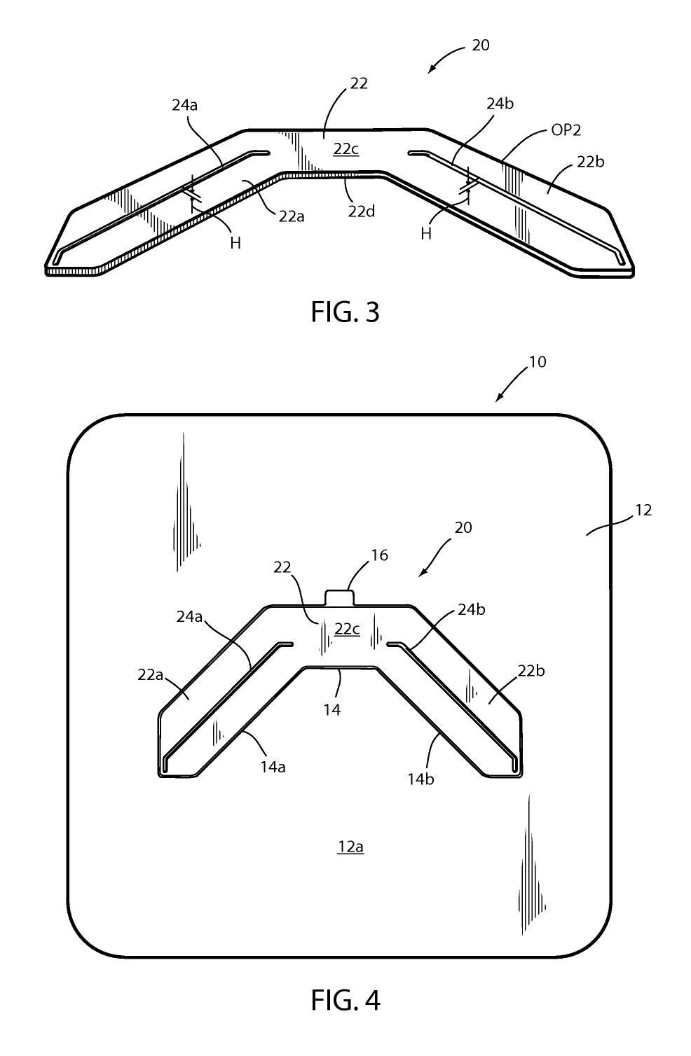

Referring now to FIG. 3, the body portion 22 of the insert 20 includes an upper side 22c and a lower side 22d. The reverse cut insert 20 is shown in FIG. 3 with the blade portions 24a, 24b extending outwardly from upper side 22c of the planar body portion 22 a distance as indicated by reference character H.

Referring now to FIG. 4, the reverse cut insert 20 has been received in receiving aperture 14, such that wing portions 22a, 22b of the insert 20 are aligned with the wing portions 14a, 14b of receiving aperture 14, thereby providing a friction fit configuration for the insert 20 relative to the counter die 10. As shown in FIG. 4, the planar body portion 12 of the counter die 10 is generally level with the body portion 22 of the insert 20. Relief notch 16 of receiving aperture 14 is shown in FIG. 4 as being accessible, such that a prying tool, like a flat head screw driver, can be inserted into relief notch 16 to pry the reverse cut insert 20 from receiving aperture 14 when removal of the insert is necessary.

As noted above, the counter die 10, having an insert 20 received therein, must be capable of repeated stampings in a die converting process. Generally, as noted above, receiving aperture 14 disposed on the counter die 10 is configured to essentially mirror the overall configuration of the insert 20, thereby providing a proper fit and alignment of the insert 20 in receiving aperture 14 in such a way that the insert 20 is retained in receiving aperture 14. However, the insert 20 must also have a certain amount of float in relation to receiving aperture 14, such that the insert 20 is easily placed in receiving aperture 14 by the die converter.

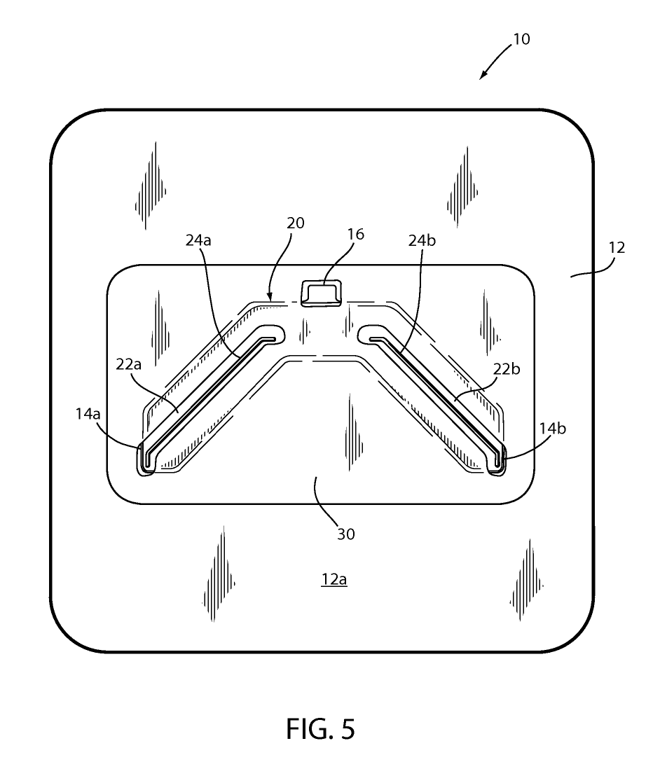

Referring now to FIG. 5, an adhesive patch 30 has been placed over a portion of the planar body portion 12 of the counter die 10 and over a portion of the insert 20 as well, which helps retain the insert 20 in receiving aperture 14 of the counter die 10 during use by coupling the insert 20 to the counter die 10. As shown in FIG. 5, the adhesive patch 30 has been cut away from blade portions 24a, 24b such that the blade portions 24a, 24b are accessible to make clean contact with a paperboard substrate during a die converting process. Further, the adhesive patch 30 has been cut away from relief notch 16, such that relief 16 will be accessible to a prying tool for removing the insert 20 when necessary. For use with the present invention, the adhesive patch 30 may include a sign tape material having a thickness of about 0.003 inches to about 0.005 inches. While a variety of adhesive patches 30 can be used with the present invention, it is noted that the material thickness of the adhesive patch 30 should be negligible, such that the adhesive patch 30 does not interfere with the die converting process.

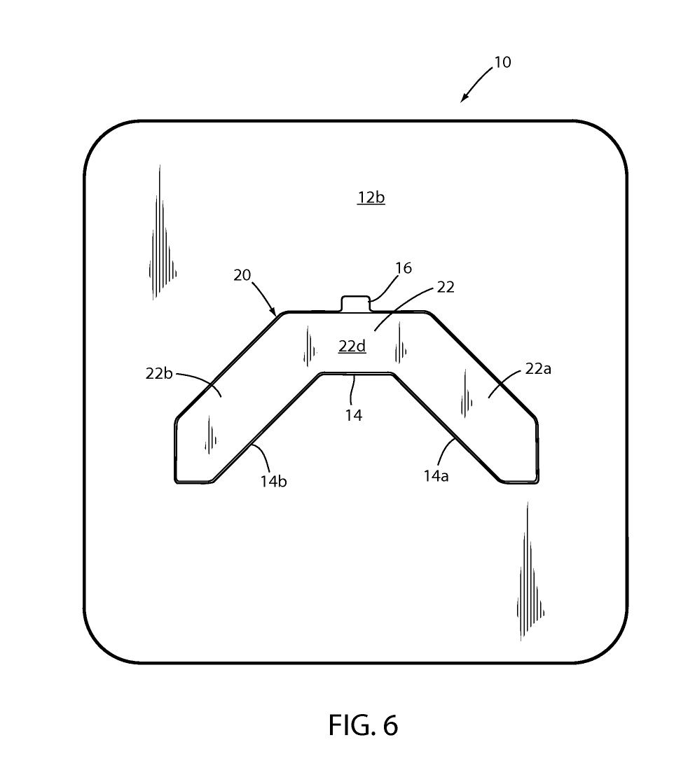

Referring now to FIG. 6, the counter die 10 and insert 20 are shown, wherein the planar body portion 22 of the insert 20 is generally aligned with the planar body portion 12 of the counter die 10, thereby providing an overall smooth and continuous undersurface for the counter die 10. Thus, the bottom surface 12b of the counter die 10 is substantially flush with the lower side 22d of the insert 20 in assembly.

Thus, the present invention provides for an insert which can be customized to have a blade extending therefrom for use in a reverse cutting process. Thus, the insert can be milled to have any configuration necessary to provide a blade with a specific configuration needed for a particular job. Thus, it is contemplated that the insert 20 shown in FIG. 3, for example, was a solid insert until the body portion 22 was milled to provide milled upper side 22c. Unmilled portions of the insert then define the blade portions 24a, 24b extending outwardly from the milled upper side 22c. As noted in FIGS. 1-6, the proposed reverse cut job for the apparatus depicted required angled blade portions 24a, 24b, which were spaced apart from each other having angled distal portions. Thus, the V-shaped body portion 22, having wings 22a, 22b, accommodated the specific blade configuration for that particular job. Using a reverse cut score of the prior art, it is likely that a channel would have to be precisely milled in the counter die to provide a channel having the basic configuration of receiving aperture 14 as found in counter die 10 of FIG. 1. The uneven milled bottom surface of the channel and the likelihood of the adhesive warming up to allow for play in the setting of the reverse cut score are factors that could lead a manufacturer to “loose the cut” and have to reset the reverse cut configuration.

The present invention eliminates these factors by providing an aperture, which is cut directly through the counter die, thereby making for an easier cut-through process as compared to milling a channel to a specific depth in a relatively thin counter die. Cutting straight through the counter die, such as counter die 10 shown in FIG. 1, is not only more precise, but also eliminates the potential of having an uneven milled surface in a channel for receiving reverse cut scores and obviates the need for any adhesives which, as noted above, are prone to reconstitution during a die converting process. The insert of the present invention, such as insert 20 found in FIG. 2, can be formed to provide a one-piece blade portion, such as blade portions 24a, 24b, which can include any variety of angles or semi-circular configurations which are difficult, if not impossible, to replicate using straight blade reverse cut scores in a milled channel of a counter die. Thus, the present invention provides for a customizable insert to be placed in an aperture of a counter die having a customized blade portion adapted for a particular job. Further, the present invention provides for an insert configuration which correlates to the aperture in the counter die to thereby retain the customized insert in the counter die during a die converting process.

A method of providing a reverse cut in a substrate in a die converting process using the present invention includes providing a counter die, such as counter die 10 described above having a generally planar body portion 12. A receiving aperture 14 is formed therethrough by cutting the counter die using a suitable cutting process. The receiving aperture 14 has a first geometric configuration disposed about an outer perimeter OP1 thereof. An insert 20 is provided having a generally planar body portion 22 with a second geometric configuration disposed about an outer perimeter OP2 of the insert 20. In this method, the second geometric configuration OP2 of the insert is complementary to the first geometric configuration OP1 of the counter die 10. One or more blade portions 24a, 24b are formed on the insert 20 by milling or other like forming process. The insert 20 is then positioned within the receiving aperture 14 of the counter die 10 on a die press. A substrate is then converted in the die press, such that the blade portions 24a, 24b of the insert provide a reverse cut on an underside of the substrate during the die converting process.

It will be understood by one having ordinary skill in the art that construction of the described invention and other components is not limited to any specific material. Other exemplary embodiments of the invention disclosed herein may be formed from a wide variety of materials, unless described otherwise herein.

The invention claimed is:

1. A reverse die cutting apparatus for use with a substrate in a die converting process comprising:
a counter die having a generally planar body portion and a receiving aperture disposed through the planar body portion, wherein the receiving aperture includes a geometric configuration relative to an outer perimeter thereof;
an insert having a generally planar body portion, wherein the insert includes a geometric configuration disposed about an outer perimeter thereof that is complementary to the geometric configuration of the receiving aperture, such that the insert is received within the receiving aperture disposed through the generally planar body portion of the counter die;
one or more blades extending outwardly from the generally planar body portion of the insert; and
wherein the insert, as received in the receiving aperture of the counter die, is configured to provide a reverse cut to the substrate during the die converting process.

2. The reverse die cutting apparatus of claim 1, wherein the insert is received in a friction fit manner within the receiving aperture.

3. The reverse die cutting apparatus of claim 1, further comprising:
a relief notch disposed along the outer perimeter of the receiving aperture.

4. The reverse die cutting apparatus of claim 1, wherein the counter die includes a top surface and a bottom surface, and further wherein the insert includes an upper side and a lower side.

5. The reverse die cutting apparatus of claim 4, wherein the lower side of the insert is substantially flush with the bottom surface of the counter die when the insert is received in the receiving aperture.

6. A method of providing a reverse cut in a substrate in a die converting process, the method including the steps of:
providing a counter die having a generally planar body portion;
forming a receiving aperture through the body portion of the counter die, the receiving aperture formed having a first geometric configuration disposed about an outer perimeter thereof;
providing an insert having a generally planar body portion and further including a second geometric configuration disposed about an outer perimeter thereof, the second geometric configuration being complementary to the first geometric configuration of the counter die;
forming one or more blade portions on the insert;
positioning the insert in the receiving aperture of the counter die;
positioning the counter die and insert in a die press; and
converting the substrate in the die press, such that the blade portions of the insert provide a reverse cut on an underside of the substrate during the converting step.

7. The method of claim 6, wherein the step of forming one or more blade portions on the insert further includes:
milling the body portion of the insert to form a milled upper side, such that the one or more blade portions extend outwardly from the milled upper side.

8. The method of claim 7, wherein the step of forming a receiving aperture through the body portion of the counter die further includes:
forming a relief notch along the outer perimeter of the receiving aperture.

9. The method of claim 8, wherein the step of positioning the insert in the receiving aperture of the counter die further includes:
frictionally fitting the insert into the receiving aperture.

10. The method of claim 9, further including:
coupling the insert to the counter die.

11. The method of claim 10, wherein the step of coupling the insert to the counter die further includes:
providing an adhesive patch over a portion of the insert and a portion of the counter die.

12. The method of claim 6, wherein the step of converting the substrate in the die press, such that the blade portions of the insert provide a reverse cut on an underside of the substrate further comprises:
pressing the counter die against a flat anvil with the substrate disposed therebetween.

13. A reverse die cutting apparatus for use with a substrate in a die converting process comprising:
a counter die having a generally planar body portion including a top surface and a bottom surface;
a receiving aperture disposed through the planar body portion, wherein the receiving aperture includes a first geometric configuration relative to an outer perimeter thereof;
an insert having a generally planar body portion, wherein the insert includes a second geometric configuration disposed about an outer perimeter thereof, the second geometric configuration being complementary and smaller than the first geometric configuration of the receiving aperture, the insert is received within the receiving aperture disposed through the generally planar body portion of the counter die; and
one or more blades extending outwardly from the generally planar body portion of the insert, wherein the one or more blades are raised relative to the top surface of the counter die.

14. The reverse die cutting apparatus of claim 13, further comprising:
a relief notch disposed along the outer perimeter of the receiving aperture.

15. The reverse die cutting apparatus of claim 14, wherein the lower side of the insert is substantially flush with the bottom surface of the counter die when the insert is received in the receiving aperture.

16. The reverse die cutting apparatus of claim 13, further comprising:
an adhesive patch partially disposed on a portion of the upper side of the insert, and partially disposed on a portion of the top surface coupling the counter die.
